(19) United States
(12) Patent Application Publication
(10) Pub. No.: US 2020/0120739 A1
(43) Pub. Date: Apr. 16, 2020

(54) METHOD OF SWITCHING CONNECTION TO NETWORK, INTELLIGENT TERMINAL, AND APPARATUS HAVING STORAGE FUNCTION

(71) Applicant: HUIZHOU TCL MOBILE COMMUNICATION CO., LTD., HUIZHOU (CN)

(72) Inventors: XIAOJUAN QIU, HUIZHOU (CN); MENGTING SHEN, HUIZHOU (CN)

(21) Appl. No.: 16/713,028

(22) Filed: Dec. 13, 2019

Related U.S. Application Data
(63) Continuation of application No. PCT/CN2018/096133, filed on Jul. 18, 2018.

(30) Foreign Application Priority Data
Jul. 18, 2017 (CN) 201710587285.7

(51) Int. Cl. H04W 76/18; H04M 1/725

(52) U.S. Cl. CPC H04W 76/18; H04W 88/06; H04M 1/72569

(57) ABSTRACT

The present application provides a network switching method, an intelligent terminal, and a device having a storage function. The network switching method includes: activating a Wi-Fi network connection function and a mobile data network connection function, connecting to a Wi-Fi network, then determining whether the currently connected to Wi-Fi network is active, and if not, automatically switching to connect to a mobile data network. By means of the method, when a Wi-Fi network connection function and a mobile data network connection function are both activated, an intelligent terminal can automatically switch to connect to a mobile data network if a currently connected to Wi-Fi network is inactive.

### CROSS REFERENCE TO RELATED APPLICATIONS

The present application is a continuation-application of International (PCT) Patent Application No. PCT/CN2018/096133 filed on Jul. 18, 2018, which claims foreign priority of Chinese Patent Application No. 201710587285.7, filed on Jul. 18, 2017, in China National Intellectual Property Administration, the contents of all of which are hereby incorporated by reference.

### TECHNICAL FIELD

The present disclosure relates to the field of intelligent terminals, and in particularly to a method of switching connection to a network, an intelligent terminal, and a non-transitory storage apparatus.

### BACKGROUND

The society is developing rapidly, and a network is necessary for people to communicate during working and daily lives. Currently, almost all mobile phones have a function of connecting to a network through wireless fidelity (Wi-Fi). After the mobile phone is connected to the network through Wi-Fi, cellular data of the mobile phone may not be required, saving cost for a user. Typically, the mobile phone may preferably connect to the network through Wi-Fi. However, after the mobile phone is connected to the network through Wi-Fi, when there is no data transmission, the mobile phone may remain as connecting with Wi-Fi, and the user may not be able to do any operation. If a mobile data network connection is activated at the same time, when no data is transmitting through Wi-Fi, the mobile phone still cannot connect to the network through the mobile data network connection, and the user has to manually deactivate the Wi-Fi connection to allow a feasible network connection. Therefore, an inconvenient operation is needed, reducing user experience.

### SUMMARY OF THE DISCLOSURE

According to the present disclosure, a method of switching connection to a network, an intelligent terminal, and a non-transitory storage apparatus may be provided. In a case of connection to a network through Wi-Fi connection being invalid, mobile data network connection may be switched to be activated to connect to the network, providing an easy operation.

According to an aspect of the present disclosure, a non-transitory storage apparatus may be provided. The non-transitory storage apparatus has program data stored in, and the program data may be executed by a processor to perform following operations.

An intelligent terminal switches on Wi-Fi connection and mobile data network connection, and a network is connected through the Wi-Fi connection.

The intelligent terminal may determine whether the Wi-Fi connection is valid.

In response to the connection to the network through the Wi-Fi connection being invalid, a request may be sent to a user to determine whether to switch to activate the mobile data network connection, and automatically activating the mobile data network connection to connect to the network after the user confirms to switch.

According to another aspect of the present disclosure, an intelligent terminal may be provided and includes a processor, and the processor may execute program data to perform following operations.

A Wi-Fi connection and a mobile data network connection may be switched on, and a network is connected through the Wi-Fi connection.

Validity of the Wi-Fi connection may be determined.

In response to the Wi-Fi connection being invalid, the mobile data network connection may be automatically activated to connect to the network after the user confirms to switch.

According to still another aspect of the present disclosure, a method of switching connection to a network may be provided and includes following operations.

An intelligent terminal switches on a Wi-Fi connection and a mobile data network connection, and a network is connected through the Wi-Fi connection.

The intelligent terminal may determine validity of the Wi-Fi connection.

In response to the Wi-Fi connection being invalid, the mobile data network connection may be activated automatically to connect to the network.

According to the present disclosure, the Wi-Fi connection and the mobile data network connection may be switched on, and the network is connected through the Wi-Fi connection; the validity of the Wi-Fi connection may be determined; and, in response to the Wi-Fi connection being invalid, the mobile data network connection may be activated automatically to connect to the network. In such a way, the Wi-Fi connection and the mobile data network connection may be switched on at the same time, the intelligent terminal may connect to the network through Wi-Fi, and the validity of the Wi-Fi connection may be determined. When the Wi-Fi connection is invalid or infeasible, the intelligent terminal may automatically activate the mobile data network connection, providing an easy operation for the user as the user may not need to manually switch off the Wi-Fi connection.

### BRIEF DESCRIPTION OF THE DRAWINGS

FIG. 1 is a flow chart illustrating a method of switching connection to a network according to an embodiment of the present disclosure.

FIG. 2 is a structural diagram of an intelligent terminal according to an embodiment of the present disclosure.

FIG. 3 is a structural diagram of an apparatus having a storage function according to an embodiment of the present disclosure.

### DETAILED DESCRIPTION

The present disclosure may be illustrated in details by referring to the drawings and embodiments.

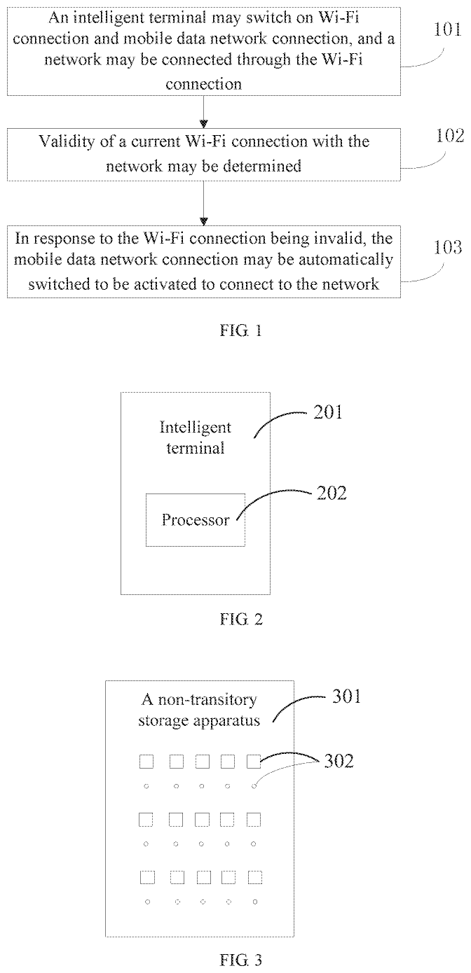

Referring to FIG. 1, a flow chart illustrating a method of switching connection to a network according to an embodiment of the present disclosure is provided. As shown in FIG. 1, the method of switching connection to a network may include following operations.

At block 101, an intelligent terminal may switch on Wi-Fi connection and mobile data network connection, and a network may be connected through the Wi-Fi connection.

The intelligent terminal may include one of a smart mobile phone, an iPad, and a laptop computer. In other embodiments, other intelligent terminals may be provided.

To be specific, a user may enter an interface of setting to switch on the Wi-Fi connection and the mobile data network connection. The intelligent terminal may receive an instruction from the user to switch on the Wi-Fi connection and the mobile data network connection, and search for a network available for connection. When the Wi-Fi connection and the mobile data network connection are both available, the Wi-Fi connection may be activated. When only one of the Wi-Fi connection and the mobile data network connection is available, the network may be connected through the available one. The mobile data network connection may be any one of mobile communication technologies, such as the fourth generation mobile communication technology, the third generation mobile communication technology, the second generation mobile communication technology, or the like.

At block 102, validity of the Wi-Fi connection may be determined.

After the intelligent terminal is connected to the network through the Wi-Fi connection, the validity of the Wi-Fi connection may be determined automatically. Specifically, the validity of the Wi-Fi connection may be determined by determining whether an external network is connected through the current Wi-Fi connection. In response to the external network being connected through the Wi-Fi connection, the Wi-Fi connection may be determined to be valid, and, in response to the external network unable to be connected through the current Wi-Fi connection, the Wi-Fi connection may be determined to be invalid. The external network may refer to an internet, and the intelligent terminal may be connected to the internet through the Wi-Fi connection or the mobile data network connection to perform network-based operations, such as browsing websites, playing online games, making network-based voice calls or video calls, downloading literature documents, and the like.

At block 103, in response to the Wi-Fi connection being invalid, the mobile data network connection may be automatically switched to be activated to connect to the network.

To be specific, in response to the current Wi-Fi connection being determined to be invalid, the external network is unable to be connected, and the intelligent terminal may automatically switch to activate the mobile data network connection.

To inform the user about a status of the Wi-Fi connection, before the intelligent switches to activate the mobile data network connection, at least one of a text message, a voice, a vibration, and a flash may be sent to inform the user that the Wi-Fi connection is unavailable, and the mobile data network connection may be switched to be activated. For example, in response to the Wi-Fi connection being determined to be invalid, a text message stating “The current Wi-Fi connection is invalid!” may be generated to inform the user, or a voice reminder, a vibration, or a flash may be generated to further alert the user.

Alternatively, after the intelligent terminal determines that the Wi-Fi connection is invalid, the intelligent terminal may further acquire an instruction of switching to activate the mobile data network connection to connect to the network or an instruction of not switching to activate the mobile data network connection to connect to the network to further improve feasibility of network connection. To be specific, after the intelligent terminal determines that the current Wi-Fi connection is invalid, the intelligent terminal may alert the user that the current Wi-Fi connection is invalid (or may not alert the user, this operation is not limited herein), and wait for the user to input an instruction of switching to activate the mobile data network connection or an instruction of not switching to activate the mobile data network. After the intelligent terminal receives the instruction of switching to activate the mobile data network connection, the mobile data network connection may be automatically switched to be activated to connect to the network. Alternatively, after the intelligent terminal determines that the Wi-Fi connection is invalid, the intelligent terminal may alert the user that the Wi-Fi connection is invalid (or may not alert the user, this operation is not limited herein), and send a request, in a form of a dialog box or a voice message, to the user to determine whether to switch to activate the mobile data network connection. After the intelligent terminal receives an instruction from the user determining to switch, the mobile data network connection may be automatically switched to be activated. That is, after the user receives the alert about the Wi-Fi connection being invalid, the user may further determine whether to switch to activate the mobile data network connection. In response to the user determining to switch to activate the mobile data network connection, the intelligent terminal may receive a switching instruction, and the mobile data network connection may be automatically switched to be activated. In such a way, it is the user that permits switching to activate the mobile data network connection, connection by mistake without notifying the user may be prevented, and the mobile data of the intelligent terminal may be saved to reduce cost for users.

For example, the intelligent terminal may determine the Wi-Fi connection is invalid, a voice and a text message alerts may be sent to the user, stating “The current Wi-Fi connection is invalid!”, and a determination dialog box stating “Please determine whether to switch to the mobile data network connection?” and dialog boxes of options “yes/confirm” and “no/cancel” may be generated for the user to make an option. In response to the user selecting “yes/confirm”, the mobile data network connection may be determined to be activated, and the intelligent terminal may receive the switching instruction and execute the instruction to switch to activate the mobile data network connection. In response to the user selecting “no/cancel”, the switching may be cancelled, and the intelligent terminal may remain as connecting to the network through the Wi-Fi connection.

Further, in response to the current Wi-Fi connection being determined to be valid, the intelligent terminal may allow the user to browse websites, play online games, and download literature documents through the Wi-Fi connection directly.

According to the method of switching connection to the network, the intelligent terminal may switch on both the Wi-Fi connection and the mobile data network connection, and the network may be connected through the Wi-Fi connection. The intelligent terminal may then determine whether the Wi-Fi connection is valid, in response to the Wi-Fi connection being invalid, the mobile data network connection may be switched to be activated automatically, and the user may not need to manually switch off the Wi-Fi connection to perform network-based operations, thus, improving user experience.

The above-mentioned method may be applied to the intelligent terminal, and logical processes may be expressed by a computer program and may be achieved by the intelligent terminal.

A hardware structure of the intelligent terminal may refer to FIG. 2. FIG. 2 shows a structural diagram of the intelligent terminal according to an embodiment of the present disclosure. As shown in FIG. 2, in the present implementation, the intelligent terminal 201 may include a processor 202, and the processor 202 may execute program data to perform operations of the method of switching connection to the network as described in the above-mentioned implementations.

In the present implementation, the processor 202 of the intelligent terminal 201 may execute program data to switch on the Wi-Fi connection and the mobile data network connection, and the network is connected through the Wi-Fi connection. Validity of the Wi-Fi connection may subsequently be determined. In response to the Wi-Fi connection being invalid, the mobile data network connection may be switched to be activated automatically, and the user may not need to manually switch off the Wi-Fi connection to perform network-based operations, which may be easy and convenient for the user.

When the computer program is placed into a market or used as an independent product in a form of software, the computer program may be stored in an electronic device-readable storage medium, that is, a non-transitory storage apparatus provided by the present disclosure. Referring to FIG. 3, a structural diagram of the non-transitory storage apparatus is provided. The non-transitory storage apparatus 301 has program data 302 stored in, and the program data 302 may be executed by the processor to execute operations of the method of switching connection to the network as described in the above-mentioned embodiments. The processor may be a processor included in the non-transitory storage apparatus 301 or a processor included in another terminal. The non-transitory storage apparatus 301 may include any apparatus capable of storing the above-mentioned program data 302, including at least one of a universal serial bus, an optical disc, a terminal, and a server. A form of the non-transitory storage apparatus 301 may not be limited by the present disclosure.

In the present implementation, when the program data 302 stored in the non-transitory storage apparatus 301 is executed, following operations may be performed. The Wi-Fi connection and the mobile data network connection may both be switched on, and the network is connected through the Wi-Fi connection. The validity of the Wi-Fi connection may be determined. In response to the Wi-Fi connection being invalid, the mobile data network connection may be switched to be activated automatically, and the user may not need to manually switch off the Wi-Fi connection to perform network-based operations, which is easy and convenient.

The above descriptions are only for the purposes of illustrating the present disclosure, but not to limit the scope of the present disclosure. Any equivalent structural or process transformation of the embodiments based on the present specification and the drawings applied directly or indirectly in other related art shall be within the scope of the present disclosure.

What is claimed is:

1. A non-transitory storage apparatus, having program data stored in, wherein the program data is able to be executed by a processor to perform operations of:
switching on, by an intelligent terminal, Wi-Fi connection and mobile data network connection, connecting to a network through the Wi-Fi connection;
determining whether the Wi-Fi connection is valid, and
in response to the Wi-Fi connection being invalid, sending a request to a user to determine whether to switch to activate the mobile data network connection, and automatically activating the mobile data network connection to connect to the network after the user confirms to switch.

2. The non-transitory storage apparatus according to claim 1, wherein the program data is able to be executed by a processor to further perform operations of:
determining whether an external network is connected through the Wi-Fi connection, wherein
in response to the external network being connected through the Wi-Fi connection, determining the Wi-Fi connection to be valid; and
in response to the external network unable to be connected through the Wi-Fi connection, determining the Wi-Fi connection to be invalid.

3. The non-transitory storage apparatus according to claim 1, wherein the mobile data network connection comprises any one of the fourth generation mobile communication technology, the third generation mobile communication technology, and the second generation mobile communication technology.

4. The non-transitory storage apparatus according to claim 1, wherein the program data is able to be executed by a processor to further perform operations of:
alerting the user that the Wi-Fi connection is invalid.

5. The non-transitory storage apparatus according to claim 4, wherein the program data is able to be executed by a processor to further perform operations of:
waiting for an instruction of switching to activate the mobile data network connection or an instruction of not switching to activate the mobile data network connection to be input, and performing the automatically activating the mobile data network connection to connect to the network after receiving the instruction of switching to activate the mobile data network connection.

6. An intelligent terminal, comprising a processor, wherein the processor is able to execute program data to perform operations of:
switching on Wi-Fi connection and mobile data network connection, connecting to a network through the Wi-Fi connection;
determining whether the Wi-Fi connection is valid; and
in response to the Wi-Fi connection being invalid, automatically activating the mobile data network connection to connect to the network.

7. The intelligent terminal according to claim 6, wherein, when determining whether the Wi-Fi connection is valid, the processor is able to execute program data to further perform operations of:
determining whether an external network is connected through the Wi-Fi connection, wherein
in response to the external network being connected through the Wi-Fi connection, determining the Wi-Fi connection to be valid; and
in response to the external network unable to be connected through the Wi-Fi connection, determining the Wi-Fi connection to be invalid.

8. The intelligent terminal according to claim 6, wherein, before the automatically activating the mobile data network connection to connect to the network, the processor is able to execute program data to further perform operations of:
alerting the user that the Wi-Fi connection is invalid.

9. The intelligent terminal according to claim 6, wherein, before the automatically activating the mobile data network connection to connect to the network, the processor is able to execute program data to further perform operations of:
alerting the user that the Wi-Fi connection is invalid; and/or
waiting for an instruction of switching to activate the mobile data network connection or an instruction of not switching to activate the mobile data network connection to be input, and performing the automatically activating the mobile data network connection to connect to the network after receiving the instruction of switching to activate the mobile data network connection.

10. A method of switching connection to a network, comprising:
switching on, by an intelligent terminal, Wi-Fi connection and mobile data network connection, connecting to a network through the Wi-Fi connection;
determining whether the Wi-Fi connection is valid; and
in response to the Wi-Fi connection being invalid, automatically activating the mobile data network connection to connect to the network.

11. The method according to claim 10, wherein the determining whether the Wi-Fi connection is valid comprises:
determining whether an external network is connected through the Wi-Fi connection, wherein
in response to the external network being connected through the Wi-Fi connection, determining the Wi-Fi connection to be valid; and
in response to the external network unable to be connected through the Wi-Fi connection, determining the Wi-Fi connection to be invalid.

12. The method according to claim 10, wherein the mobile data network connection comprises any one of the fourth generation mobile communication technology, the third generation mobile communication technology, and the second generation mobile communication technology.

13. The method according to claim 10, wherein, before the automatically activating the mobile data network connection to connect to the network, the method further comprises:
alerting the user that the Wi-Fi connection is invalid.

14. The method according to claim 13, wherein, before the automatically activating the mobile data network connection to connect to the network, the method further comprises: waiting for an instruction of switching to activate the mobile data network connection or an instruction of not switching to activate the mobile data network connection to be input, and performing the automatically activating the mobile data network connection to connect to the network after receiving the instruction of switching to activate the mobile data network connection.

15. The method according to claim 10, further comprising: in response to the Wi-Fi connection being valid, connecting to the network and performing network-based operations through the Wi-Fi connection.
